(19) United States
(12) Patent Application Publication
(10) Pub. No.: US 2016/0185361 A1
(43) Pub. Date: Jun. 30, 2016

(54) Locomotive Traction Motor Bearing with Separate Lubricant Reservoir

(71) Applicant: Electro-Motive Diesel, Inc., LaGrange, IL (US)

(72) Inventor: Kevin Brinker, LaGrange, IL (US)

(73) Assignee: Electro-Motive Diesel, Inc., LaGrange, IL (US)

(21) Appl. No.: 14/974,111

(22) Filed: Dec. 18, 2015

Related U.S. Application Data
(60) Provisional application No. 62/097,718, filed on Dec. 30, 2014.

(51) Int. Cl. B61C 17/08; B61C 17/10; B61C 9/38; F16C 33/66; B61C 3/00

(52) U.S. Cl. CPC B61C 17/08; F16C 33/664; B61C 3/00; B61C 9/38; B61C 17/10

(57) ABSTRACT

A traction motor assembly includes a traction motor bearing that is equipped with a concealed and built-in lubricant reservoir. The traction motor bearing is disposed between inboard components and outboard components that are designed to provide annular clearances on either side of the traction motor bearing. These annular clearances may be exploited as a lubricant reservoir for the traction motor bearing. Lubricant can be added to the reservoir through ports disposed in the outboard cover. The disclosed design avoids the need to rely upon the lubricant reservoir used to lubricate the pinion and drive gears, which is subject to damage during normal rail operations.

### CROSS-REFERENCE TO RELATED APPLICATION

This is a non-provisional application claiming priority under 35 U.S.C. §119(e) to U.S. Provisional Ser. No. 62/097,718 filed on Dec. 30, 2014.

### FIELD OF THE DISCLOSURE

This patent document relates to the lubrication of bearings and more specifically to the lubrication of locomotive traction motor bearings. Still more specifically, this patent document discloses a traction motor bearing for a pinion tube, wherein the traction motor bearing has a separate lubricant reservoir that is isolated from the lubricant reservoir for the drive gear and pinion gear.

### BACKGROUND OF THE DISCLOSURE

Electrically powered rail vehicles, such as diesel electric locomotives, may employ a plurality of traction motors, typically one for each axle, to provide sufficient towing power for hauling large payloads over long distances. In some cases, the traction motors are connected in series or parallel, so that they can operate from a common electrical bus, simplifying wiring and electric control of the motors. Traction motors are available in a variety of designs including “nose suspended” DC traction motors and various types of AC traction motors.

The nose suspended traction motor is the traditional traction motor design. Such a traction motor outputs rotational motion to a rotor shaft, which couples to a pinion, or more specifically to a pinion tube, which in turn, couples or connects to a pinion gear. The pinion tube and pinion gear are typically unitary and are often collectively referred to as the pinion. The pinion gear enmeshes with a drive gear that is coupled to an axle. The pinion gear and drive gear may be disposed within a gear case. The axle couples to a wheel.

The pinion tube, or the tubular portion of the pinion, passes through an annular traction motor bearing, which supports the pinion tube and which requires lubrication. Lubrication of the traction motor bearing is critical due to the overhanging of the pinion on the drive side of the traction motor. Specifically, the overhanging configuration of the pinion causes substantial radial forces on the traction motor bearing. Further, the drive gear and pinion gear, which are disposed outboard of the pinion tube and the traction motor bearing, also require lubrication. Typically, a single lubricant reservoir services both the traction motor bearing as well as the drive and pinion gears. The single lubricant reservoir may be disposed within the gear case or another location outboard of the traction motor bearing, such as the axle cap, as disclosed in U.S. Pat. No. 2,768,035. However, due to its outboard position, the lubricant reservoir and/or the gear case can be damaged during rail operations, which can lead to a loss of the lubricant supply and both traction motor bearing failure and gear failure.

Gear failure, due to lack of lubrication, is less critical than traction motor bearing failure because the wheel is still free to rotate if the gear teeth sheer off or fail. However, if the traction motor bearing fails due to lack of lubrication and the gear teeth remain intact, the wheel becomes locked, which may be more problematic.

Thus, there is a need for a lubricating system for traction motors that includes a lubricant reservoir for the traction motor bearing that is less susceptible to damage during rail operations.

### SUMMARY OF THE DISCLOSURE

In one aspect, this patent document discloses a traction motor assembly. The traction motor assembly may include a traction motor coupled to a rotor shaft. The rotor shaft may be coupled to a pinion tube and the pinion tube may be connected to a pinion gear. The rotor shaft may pass through at least one outer rotor seal and an annular plate. The pinion tube may pass through an annular traction motor bearing and an annular cover. The traction motor bearing may be disposed within an annular bearing housing. The traction motor bearing may be disposed between the plate and the cover with a first annular clearance disposed between the traction motor bearing and the plate. The first annular clearance may accommodate lubricant that is in communication with the traction motor bearing.

In another aspect, this patent document discloses a locomotive. The locomotive may include at least one traction motor coupled to a rotor shaft. The rotor shaft may be coupled to a pinion tube and the pinion tube may be connected to a pinion gear. The rotor shaft may pass through at least one outer rotor seal and an annular plate. The pinion tube may pass through an annular traction motor bearing and an annular cover. The traction motor bearing may be disposed within an annular bearing housing. The traction motor bearing may be disposed between the plate and the cover with a first annular clearance between the traction motor bearing and the plate. Further, a second annular clearance may be disposed between the traction motor bearing and the cover. The first annular clearance may accommodate lubricant that is in communication with the traction motor bearing and the second annular clearance may accommodate lubricant that is in communication with the traction motor bearing.

In another aspect, this patent document discloses a method for providing a dedicated lubricated reservoir for a traction motor bearing of a traction motor assembly. The method may include providing a traction motor coupled to a rotor shaft, installing a rotor bushing on the rotor shaft, installing an inner rotor seal on the rotor bushing, installing an annular plate on the inner rotor seal and installing an outer rotor seal on the rotor shaft and the annular plate. The method may further include providing a pinion tube that is connected to a pinion gear, coupling the rotor shaft to the pinion tube, installing a traction motor bearing on the pinion tube, installing a cover bushing on the pinion tube with the traction motor bearing disposed between the rotor bushing and the cover bushing and installing a cover seal on the cover bushing and installing an annular cover on the cover seal. In such a method, the rotor bushing has an axial length that is greater than axial lengths of the inner rotor seal and the annular plate. The rotor bushing may be sandwiched between the traction motor bearing and the outer rotor seal with the inner rotor seal and the annual plate being axially spaced apart from the traction motor bearing to define a first annular clearance between the traction motor bearing and the inner rotor seal and between the traction motor bearing and the annular plate.

The features, functions, and advantages discussed above may be achieved independently in various embodiments or may be combined in yet other embodiments, further details of which can be seen with reference to the following description and drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a side plan view of a locomotive that may include one or more traction motors.

FIG. 2 is a sectional and schematic illustration of a traction motor, rotor shaft, pinion, traction motor bearing assembly, drive gear, gear case, axle and wheel.

FIG. 3 is a sectional view the traction motor bearing assembly shown in FIG. 2.

The drawings are not necessarily to scale and illustrate the disclosed embodiments diagrammatically and in partial views. In certain instances, this disclosure may omit details which are not necessary for an understanding of the disclosed methods and apparatuses or which render other details difficult to perceive. Further, this disclosure is not limited to the particular embodiments illustrated herein.

### DETAILED DESCRIPTION OF THE DISCLOSURE

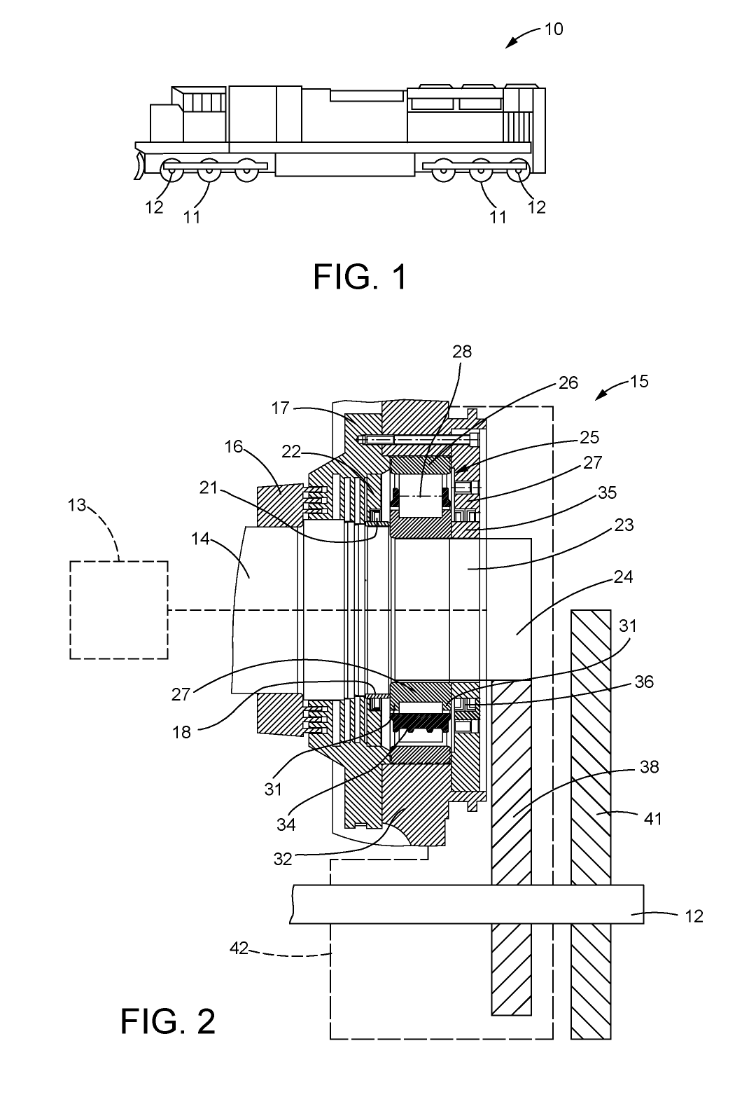

FIG. 1 illustrates and exemplary locomotive 10 in which disclosed assemblies and methods for delivering lubricant to make traction motor bearings may be implemented. The locomotive 10 may be any electrically powered rail vehicle employing DC traction motors for propulsion. Further, any electrically powered vehicle employing DC traction motors for propulsion could also incorporate the disclosed assemblies and methods for delivery lubricant to traction motor bearings. The locomotive 10 may include six pairs of wheels 11, with each pair of wheels 11 connected to an axle 12 that rotatably couples to a traction motor 13 as shown in FIG. 2. Each traction motor 13 may include an armature and a field circuit (not shown) that act to impart rotation to a rotor shaft 14 as shown in FIG. 2

FIG. 2 illustrates a traction motor assembly 15 that includes the traction motor 13 coupled to the rotor shaft 14. The rotor shaft 14 passes through an inboard rotor seal 16 and an outboard rotor seal 17. The rotor shaft 14 also passes through a rotor bushing 18 that is disposed within an inner rotor seal 21 that, in turn, is disposed within an annular plate 22. The rotor shaft 14 also connects or couples to a pinion tube 23 that connects to a pinion gear 24. The pinion tube 23 passes through a traction motor bearing 25, which may include an outer ring 26, an inner ring 27 and a plurality of rollers 28 disposed between the outer and inner rings 26, 27. The rollers 28 may be cylindrical and therefore the traction motor bearing 25 may be a cylindrical roller bearing. More specifically, the traction motor bearing 25 may be of an “N design” wherein the inner ring 27 includes a pair of radially outwardly extending flanges 31 that retain the rollers 28 between the inner ring 27 and the outer ring 26. The outer ring 26 may be smooth. Such a design of the traction motor bearing 25 allows for some axially displacement of the pinion tube 23 relative to the bearing housing 32, within certain limits. The traction motor bearing 25 as illustrated in FIG. 2 is a non-locating bearing unit, meaning that axial displacement of the pinion tube 23 relative to the bearing housing 32 in either direction is possible. A bearing cage 34 separates the rollers 28.

The traction motor bearing 25 is sandwiched between the rotor bushing 18 and the cover bushing 35. The cover bushing 35 fits mateably within a cover seal 36 that, in turn, fits within a cover 37.

The pinion gear 24 enmeshes with a drive gear 38, which mounts on the axle 12 for imparting rotation to the axle 12. The axle 12 passes through and connects to a wheel 41. A gear case 42 encloses the pinion gear 24, drive gear 38 and traction motor bearing 25 as shown schematically in FIG. 2.

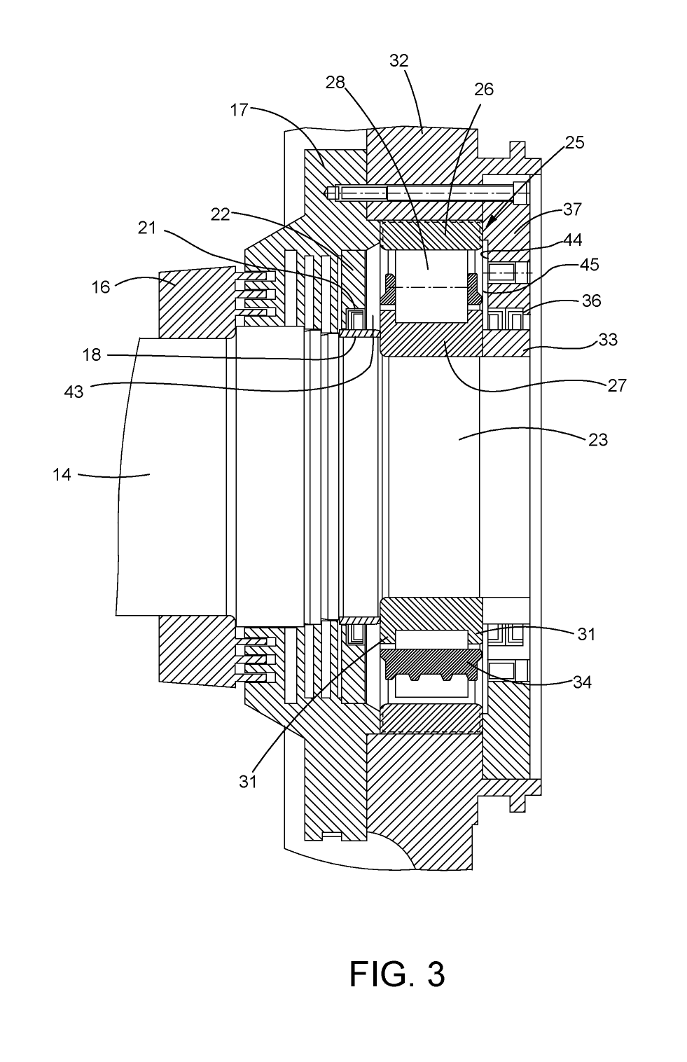

FIG. 3 provides a larger illustration of the traction motor bearing 25 and surrounding components. The traction motor bearing 25 or, more specifically, the inner ring 27 of the traction motor bearing 25 is sandwiched between the rotor bushing 18 and the cover bushing 35. Further, the rotor bushing 18 has an axial length that is greater than the axial lengths of the inner rotor seal 21 or the annular plate 22. As a result, spacing between the inner ring 27 of the traction motor bearing 25 and the inner rotor seal 21 and spacing between the outer ring 26 of the traction motor bearing 25 and the annular plate 22 create a first annular clearance 43. The first annular clearance 43 terminates, at its outer periphery, at the outboard rotor seal 17. This first annular clearance 43 is important as it is in communication with the rollers 28 of the traction motor bearing 25. Applicant exploits the first annular clearance 43 by using it as a lubricant reservoir.

Further, a recess 44 is disposed on the inboard side of the cover 37. The recess 44, in combination with the traction motor bearing 25, defines a second annular clearance 45 that is also in communication with the rollers 28 of the traction motor bearing 25. The second annular clearance 45 may also serve as a lubricant reservoir or part of the lubricant reservoir provided by the first annular clearance 43. Both the first annular clearance 43 and the second annular clearance 45 are in fluid communication with the traction motor bearing 25 or, more specifically the rollers 28 of the traction motor bearing 25.

### INDUSTRIAL APPLICABILITY

The disclosed traction motor assembly 15 includes a built-in and protected lubricant reservoir in the form of one or more annular clearances 43, 45 that are disposed between the cover 37 and the outboard rotor seal 17. Damage to the reservoir is practically impossible, unless a catastrophic event has occurred. Thus, by avoiding the placement of lubricant reservoir at an outboard position, such as in the axial cap, damage to the lubricant reservoir that provides lubricant to the traction motor bearing 25 during normal rail operations is avoided.

The disclosed traction motor assembly 15 may be employed in a locomotive 10 or in other electrically empowered rail vehicles employing DC traction motors for propulsion.

While only certain embodiments of been set forth, alternative embodiments and various modifications will be apparent from the above description to those skilled in the art. These and other alternatives are considered equivalents and within the spirit and scope of the present disclosure.

What is claimed is:

1. A traction motor assembly, comprising:
a traction motor coupled to a rotor shaft, the rotor shaft coupled to a pinion tube, the pinion tube connected to a pinion gear,
the rotor shaft passing through at least one outer rotor seal and an annular plate,
the pinion tube passing through an annular traction motor bearing and an annular cover, the traction motor bearing disposed within an annular bearing housing, the traction motor bearing disposed between the plate and the cover with a first annular clearance between the traction motor bearing and the plate, that first annular clearance accommodating lubricant that is in communication with the traction motor bearing.

2. The traction motor assembly of claim 1 further including a second annular clearance disposed between the traction motor bearing and the cover, the second annular clearance accommodating lubricant that is in communication with the traction motor bearing.

3. The traction motor assembly of claim 1 wherein the cover includes at least one port in communication with the traction motor bearing.

4. The traction motor assembly of claim 1 wherein the cover includes at least one port in communication with the traction motor bearing and the first annular clearance.

5. The traction motor assembly of claim 2 wherein the cover includes at least one port in communication with the second annular clearance.

6. The traction motor assembly of claim 2 wherein the cover includes at least one port in communication with the second annular clearance and the traction motor bearing.

7. The traction motor assembly of claim 1 wherein the traction motor is a nose suspended traction motor.

8. The traction motor assembly of claim 1 wherein the traction motor bearing is a cylindrical roller bearing.

9. The traction motor assembly of claim 8 wherein the traction motor bearing is of an N design.

10. The traction motor assembly of claim 1 wherein an outer periphery of the first annular clearance is at least partially defined by the outer rotor seal.

11. The traction motor assembly of claim 1 wherein the rotor shaft passes through a rotor bushing that is at least partially accommodated within an inner rotor seal that is at least partially accommodated within the annular plate, and the first annular clearance is defined by the rotor bushing, the inner rotor seal, the plate, the rotor bushing, the outer rotor seal and the traction motor bearing.

12. The traction motor assembly of claim 2 wherein the traction motor bearing provides communication between the first annular clearance and the second annular clearance.

13. The traction motor bearing of claim 2 wherein the pinion tube passes through a cover bushing that is accommodated within a cover seal that is accommodated within the cover, the second annular clearance is defined by the cover, the cover bushing, the cover seal and the traction motor bearing.

14. A locomotive, comprising:
at least one traction motor coupled to a rotor shaft, the rotor shaft coupled to a pinion tube, the pinion tube connected to a pinion gear,
the rotor shaft passing through at least one outer rotor seal and an annular plate,
the pinion tube passing through an annular traction motor bearing and an annular cover, the traction motor bearing disposed within an annular bearing housing, the traction motor bearing disposed between the plate and the cover with a first annular clearance between the traction motor bearing and the plate and a second annular clearance disposed between the traction motor bearing and the cover,
that first annular clearance accommodating lubricant that is in communication with the traction motor bearing, the second annular clearance accommodating lubricant that is in communication with the traction motor bearing.

15. The locomotive of claim 14 wherein the cover includes at least one port in communication with the traction motor bearing.

16. The locomotive of claim 14 wherein an outer periphery of the first annular clearance defined by the outer rotor seal.

17. The locomotive of claim 14 wherein the rotor shaft passes through a rotor bushing that is at least partially accommodated in an inner rotor seal that is at least partially accommodated in the annular plate, and the first annular clearance is defined by the plate, the rotor bushing, the inner rotor seal, the outer rotor seal and the traction motor bearing.

18. The locomotive of claim 14 wherein the pinion tube passes through a cover bushing that is accommodated within a cover seal that is accommodated within the cover, the second annular clearance is defined by the cover, the cover bushing, the cover seal and the traction motor bearing.

19. A method for providing a dedicated lubricant reservoir for a traction motor bearing of a traction motor assembly, the method comprising:
providing a traction motor coupled to a rotor shaft,
installing a rotor bushing on the rotor shaft,
installing an inner rotor seal on the rotor bushing,
installing an annular plate on the inner rotor seal,
installing an outer rotor seal on the rotor shaft and the annular plate,
providing a pinion tube that is connected to a pinion gear,
coupling the rotor shaft to the pinion tube,
installing a traction motor bearing on the pinion tube,
installing a cover bushing on the pinion tube with the traction motor bearing disposed between the rotor bushing and the cover bushing,
installing a cover seal on the cover bushing and installing an annular cover on the cover seal,
wherein the rotor bushing has an axial length that is greater than axial lengths of the inner rotor seal and the annular plate, the rotor bushing being sandwiched between the traction motor bearing and the outer rotor seal with the inner rotor seal and annular plate being axially spaced apart from the traction motor bearing to define a first annular clearance between the traction motor bearing and the inner rotor seal and between the traction motor bearing and the annular plate.

20. The method of claim 19 wherein the cover includes an inboard recess that defines a second annular clearance disposed between the cover and the traction motor bearing.
